(19) United States
(12) Patent Application Publication
(10) Pub. No.: US 2010/0162865 A1
(43) Pub. Date: Jul. 1, 2010

(54) DEFECT-CONTAINING STRIP AND METHOD FOR DETECTING SUCH DEFECTS

(75) Inventor: JEFFREY GLENN INNOCENZO, Towanda, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/577,870

(22) Filed: Oct. 13, 2009

Related U.S. Application Data
(60) Provisional application No. 61/141,893, filed on Dec. 31, 2008.

(51) Int. Cl. B26D 5/32; B32B 3/00; B05D 5/06

(52) U.S. Cl. 83/73; 428/195.1; 427/8

(57) ABSTRACT

The present invention provides a method for recognizing the presence of at least one defect in a strip of film and identifying its position during film manufacturing; a method for removal of the portion of the film strip containing the defect; and a film strip having at least one defect recognized and its position identified.

### BACKGROUND OF THE INVENTION

1. Field of the Invention

The present invention pertains to a method for detecting and marking, and prior to use, removing one or more defects on or in a film strip, as well as the film strip itself containing defects that have been recognized and marked.

2. Description of Related Art

Color filters are utilized in the production of devices using liquid crystal displays. In the production of such devices, the color filter can be constructed from thermal color donor film sheets, such as a red, blue and green donor sheet, which are consecutively applied to, imaged, and removed from a substrate. Prior to their application to the substrate, the film sheets can be stored uncut as large rolls of film strip, wherein the rolls are wound at the end of the film strip production line. Prior to use, a desired length of film strip is unrolled and cut to provide the film sheet applied to the substrate. A convenient size is somewhat larger (e.g. a few centimeters on each side) from the surface being treated, to allow for hold-down of the sheet to the substrate, for example by a vacuum table.

A typical substrate used in the production of color filters is glass, optionally with a black matrix delineating areas to be colored. Due to the great expense of the substrate, the donor film sheets applied thereon are desired to be free of defects, since any defects present in the donor film sheet will lessen the quality of the color filter and possibly cause the color filter to be rejected for use. Film sheet defects can result from the presence of dirt particles during production or unrolling, or streaks and scratches that occur during the film production process or later. As a result, the industry has attempted to consistently produce film sheets free of any defects; however such attempts have not met with success due to the very low probability of producing long film strips completely free of defects.

Thus, there is a need and desire within the industry for a process and product capable of consistently providing high quality film sheets that are either free of defects or the defect(s) are within a predetermined severity threshold, thereby allowing for a greater proportion of the finished roll to be utilized in an appropriate end-use application. When the highest quality film strip can not be produced, there is a need to utilize high-quality defect-free portions of the film strip as high quality film sheets, avoiding defect containing portions of the film strip.

### SUMMARY OF THE INVENTION

The present invention provides a method for detecting and marking, and prior to use, removing one or more defects on or in a film strip, as well as the film strip itself containing defects that have been recognized and marked.

The present invention pertains to a film strip having a longitudinal axis oriented in the winding direction. The film strip is adapted for cutting into film sheets having a length of at least D. The film strip contains at least one defect; and at least one mark on the film strip corresponding to each defect. Typically, each mark is positioned at a distance of at least D from the corresponding defect, measured on the longitudinal axis. Preferably such marks are made on the edge or an unused portion such as the back of the film strip rather than on a used portion of the film strip or on the exact location of a defect.

One embodiment of the present invention provides a method of marking the film strip containing at least one defect, the longitudinal axis of the film strip is oriented along a winding direction and the film strip is adapted for cutting into sheets having a length of at least D, the method including detecting the at least one defect; and recording at least one mark on the film strip corresponding to each defect, wherein each mark is positioned at a distance of at least D from the corresponding defect.

Another embodiment of the present invention includes a method of removing a portion of a film strip containing at least one defect, the film strip having a longitudinal axis oriented along a winding direction and adapted for cutting into sheets having a length of at least D, the method comprising moving the film strip past a cutting means for cutting the film strip and a means for reading marks on the film strip corresponding to each defect, wherein each mark is positioned at a distance of at least D from the corresponding defect; cutting the film strip at a position between the at least one defect and the corresponding mark; and cutting the film strip when the means for reading the mark reads no additional marks over a distance of at least D, thereby removing the defect-containing portion of the film strip.

Another embodiment of the present invention includes a method of marking a film strip and cutting the film strip, the film strip containing at least one defect, the film strip having a longitudinal axis oriented along a winding direction and adapted for cutting into sheets having a length of at least D, the method comprising: detecting the at least one defect; and recording at least one mark on the film strip corresponding to each defect, wherein each mark is positioned at a distance of at least D from the corresponding defect; and removing a portion of the film strip, comprising: moving the strip containing at least one defect past a means for reading marks on the film strip corresponding to each defect and also past a cutter for cutting the film strip, wherein each mark is positioned at a distance of at least D from the corresponding defect; cutting the film strip at a position between the at least one defect and the corresponding mark; and cutting the film strip when a means for reading marks reads no additional marks for a distance of at least D, thereby removing the defect-containing portion.

### BRIEF DESCRIPTION OF THE DRAWINGS

FIG. 1 is a perspective view showing the alignment of a film sheet with a receiver element to produce an assemblage.

FIG. 2 is a perspective view showing a partially unwound roll of defect-containing film strip aligned with a means of detection, a means for reading marks, a means for marking, and a means for cutting.

FIG. 3 is a diagrammatic view showing an embodiment of the present invention where a film strip containing a defect has a mark identifying the defect.

FIG. 4 is a diagrammatic view showing an alternative embodiment of the present invention where a film strip containing a defect has a mark identifying the defect.

FIG. 5 is a diagrammatic view of another alternative embodiment of the present invention where a film strip containing several defects has corresponding marks identifying the defects.

### DETAILED DESCRIPTION OF THE PREFERRED EMBODIMENT(S)

The present invention provides (1) methods for recognizing and recording the presence of at least one defect in a strip of film and identifying its position during film manufacturing, such that as the film is wound onto a storage roll (i.e. a finished roll), the defect has been recognized and accounted for so that the defect-containing film strip portion may be cut from the film strip and discarded or retained as appropriate prior to application of non-defective film sheets onto a substrate; (2) methods for removal of the portion of the strip containing the defect; and (3) film strips having at least one defect recognized and its position identified.

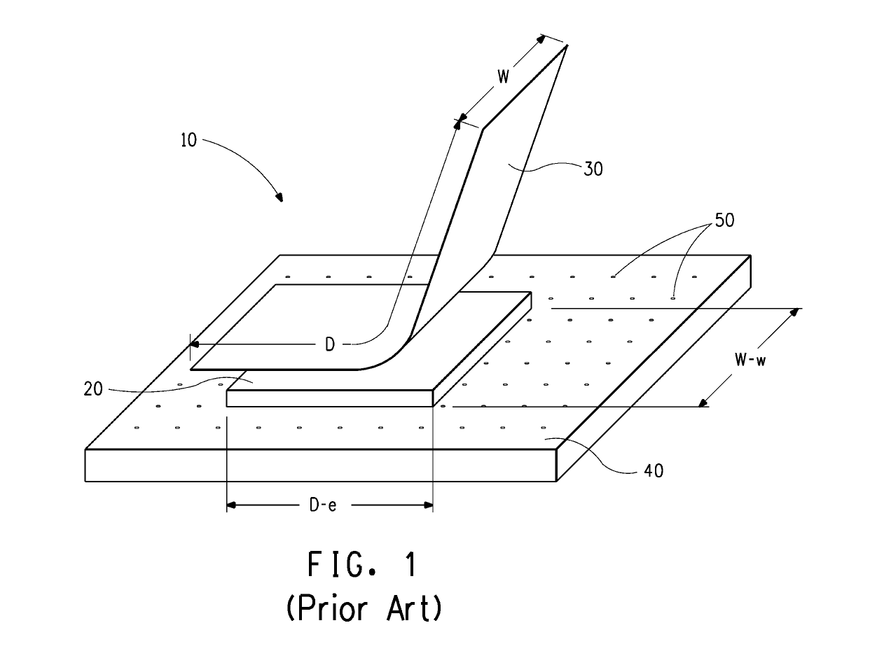

FIG. 1 shows one use of a film sheet known in the prior art, where the film sheet is a radiation-imagable donor element in an assemblage with a receiver element (10) suitable for thermal imaging of the prior art. The use of a non-defective film sheet (30) cut from a film strip is common. The non-defective film sheet (30) can be a donor element suitable for placement onto a color filter receiver element (20) in order to transfer portions of the donor element onto the color filter receiver element (20) by means of heat associated with imagewise illumination by a laser or other light source. In the case of a color filter suitable for a liquid crystal display, the film strip can comprise a colored transferable layer facing the receiver element and an adjacent support layer opposite the receiver element. The colored transferable layer can comprise a pigment, a dye, a binder, a polymer, or a combination thereof.

A vacuum table (40) providing vacuum at ports (50) can hold the color filter receiver element (20) with its rectangular receiving side of length D-e (e greater than or equal to zero) and width W-w (w greater than or equal to zero) facing the non-defective film sheet (30). The non-defective film sheet (30) is of length D and width W. When the non-defective film sheet (30) lays partly on the vacuum table on all sides of the color element receiver element, such as when e or w is greater than zero and compensates for the thickness of the color filter receiver element (20) and the spacing of the vacuum ports (50) so as to cover a suitable number of vacuum ports adjacent the 4 edges of the color filter receiver element (20), the vacuum table can hold the non-defective film sheet (30) in close contact with the color filter receiver element (20), with the colored transparent transferable layer contacting the receiving side of the receiver element. An assemblage of the donor element and the receiver element on the vacuum table can be imagewise irradiated to transfer portions of colored transparent transferable layer to the receiver element, and later the donor element support layer and untransferred colored transparent transferable layer can be peeled away from the imaged receiver element.

Methods partially illustrated in FIG. 1 are familiar from U.S. Pat. No. 5,229,232 to Longobardi et al., issued Jul. 20, 1993, entitled “Method of making thermally-transferred color filter arrays with incorporated black matrix using electronic light flash”, U.S. Pat. No. 6,057,067 to Isberg et al., issued May 2, 2000, entitled “Method for preparing integral black matrix/color filter elements”, U.S. Pat. No. 6,645,681 to Andrews et al., issued Nov. 11, 2003, entitled “Color filter”, and EP 770,222 B1 to Wolk, at al., issued Apr. 16, 2003, entitled “Methods for Preparing Color Filter Elements using Laser Induced Transfer of Colorants”. The present invention provides a means of producing non-defective film sheets (30) from a longer, defect-containing film strip.

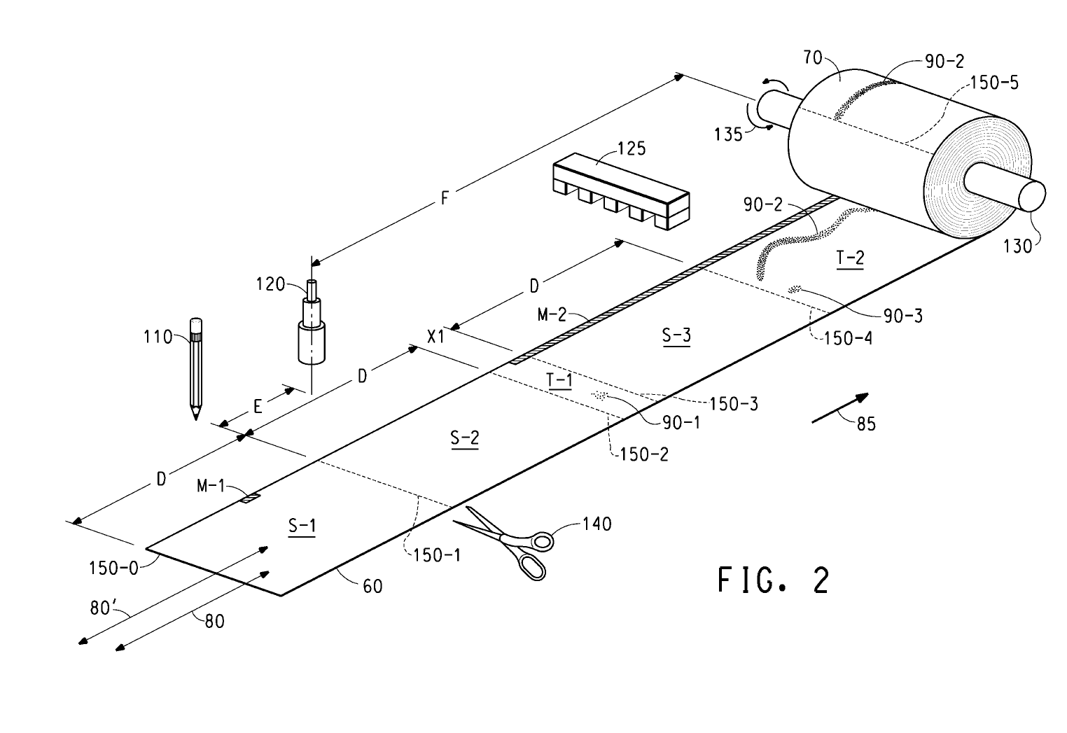

FIG. 2 shows one embodiment of the present invention where a defect-containing film strip (60) is partly wound onto a roll (70), for example by appropriate (counter-clockwise) rotation (135) of the roll (70) about its axis (130). The long direction of an unrolled portion of the defect-containing film strip (60) is parallel to one or more mutually parallel longitudinal axes (80, 80′), with the longitudinal axis (e.g. 80′) defined as from the free end of the film strip (150-0) along (e.g. parallel to, in the winding direction) (85) towards the roll (70) along the surface of the film strip. The winding direction is also termed the upstream direction, being the opposite of the downstream direction.

The roll (70) is a conventional compact means to store the long film strip. The film strip can be wound or unwound from the roll by rotation about the central axis of the roll. The roll typically includes a core contacting one end of the film strip, the film strip then being wound in laps around the core, increasing the diameter of the roll, until an appropriate length of film strip is stored on the roll.

During manufacture and wind-up of the defect-containing film strip (60), defects such as a short defect (90-1) and a long defect (90-2) can occur. Such defects can be observed by a means of defect detection (125) such as a human observer or optical system such as in U.S. Pat. No. 4,951,223 to Wales et al., issued Aug. 21, 1990, entitled “Web material inspection system”, or U.S. Pat. No. 4,237,539 to Piovoso et al., issued Dec. 2, 1980, entitled “On-line web inspection system”. The means of defect detection can be an expensive, high resolution, large area observation means. A means of marking (110) can place a mark (M) on the defect-containing film strip (60) corresponding to the defect. In this embodiment, the mark is placed on the edge of the filmstrip, (a portion of the mark) at least at a distance D from the defect, measured along the longitudinal axis. The mark can extend as long along the longitudinal axis as the corresponding defect, or separate marks can be used for the end and beginning of a defect, or other types of marks can be used, e.g. text or color.

In the case that more than one defect is found perpendicular to the longitudinal axis at a single position of the longitudinal axis, a single corresponding mark at a distance of D or more can be made for one and only one defect, or more than one mark can be made corresponding to more than one defect, or a single mark can be made for a combination of defects. This is practical because the finding of even one defect is sufficient to mark a position for discard, and further marks may not add any useful information.

The mark can encode information by various means such as color, shape, spelling, etc., as well as position. The mark can be made on the side containing the corresponding defect, or on the opposite side, or even on the sides neither the same nor opposite (typically the edges). In a preferred embodiment, the mark is placed so that upon being taken up on the roll by winding in, the mark is downstream of the corresponding defect. In other words, when the film strip is unwound from the roll, the portion of the mark at a distance D will move off the roll and be visible by direct observation before the defect is directly observed, and the roll will have to unwind a further distance of at least D before the first portion of the defect will be unwound and visible by direct observation. This is advantageous since a mark is typically easier to observe than its corresponding defect.

In one embodiment, during manufacture, some or all marks can be placed upstream to corresponding defects. A particular instance is when the film strip is transferred onto another roll prior to use, as can happen when for example a 3 meter diameter roll is transferred onto multiple rolls that can be no more than 1 meter in diameter.

In one embodiment shown in FIG. 2 when the film strip is wound off the roll, the defect-containing film strip (60) can be cut into a plurality of film sheets of length D using a means of cutting (130) such as scissors or an automated cutter. In FIG. 2, at location 150-0, the film strip (60) has been previously cleanly cut by the means of cutting. The film strip (60) can be wound off the roll (70) by rotation opposite to direction 135. The means of defect detection (125) can be used to observe the location of marks rather than defects, which leads in this case to a warning of the upcoming defect(s) that must be excluded. However, it is usually more convenient to provide a means for reading marks (120), that is typically less expensive, lower resolution, and needs to examine only a smaller, known portion of the width of the film strip for marks. When a defect-free length of film strip is unrolled from the last cut, as indicated by the appropriate lack of marks over a distance of unrolling being observed by the means of detection, the means of cutting can remove that defect free section of a length D. In this case, the imaginary cutting line at 150-1 shows the next location for cutting a non-defective film sheet.

In the embodiment of FIG. 2 where a mark is placed a sufficiently long distance downstream of the corresponding defect in the earlier detection and roll-up, the detection of marks during roll-out of the strip predicts whether a defect would be included in the next section of a film sheet, or should be removed from the workflow in a discarded film sheet due to defect(s). If mark(s) indicate upcoming defects, the film portion is designated as off-specification, and an appropriate section is cut off at a point where further unwinding of the film strip will give a defect-free section of film sheet. The appropriate section for discarding could be longer or shorter or coincidentally the same as the length D, depending on the size, location, and number of defects.

This sequence can be imagined in FIG. 2 where the film strip is partially unwound. Unwinding by rotation opposite to (135) first brings a defect-free portion of film strip under the scrutiny of the means for reading marks (120) until the means of cutting is aligned with the proposed cut (150-1). This cut will be made by a means of cutting (140), such as scissors or a flying cutter. The rectangular portion of non-defective film sheet encompasses the area S-1. Somewhat prior to the cutting, a mark indicating a defect has been encountered by the means for reading marks (120), indicating the next defect will not interfere with obtaining a defect free portion of length D, so a defect-free film sheet of length equal to or greater than D is assured by further unwinding of the film strip. In this case, the spacing between the most downstream portion of the mark (M-1) and the most downstream portion of the corresponding defect (90-1) is greater that D and sufficient to give the area S-2 as a defect free length of film sheet. As this unwinding continues, the means for reading marks (120) encounters a first mark (M-1). This first mark (M-1) indicates that after the next cut (across the line 150-2) is made, separating the second defect-free film sheet, that a defect would be included if the next film sheet was routinely made by cutting after a further D distance along the longitudinal axis is covered. A defective portion of film strip lies ahead before a third full sized, defect-free sheet can be made. Therefore, a third cut (150-3) would be made, producing a defective film sheet (T-1) containing the defect (90-1) indicated by the mark M-1. The defective film sheet (T-1) containing the defect (90-1) can be discarded or put to alternative use such as ingredient recovery or use in a system where a smaller film sheet is acceptable. At this point, the cutting at location 150-3, no second defect mark has been encountered, so a third defect-free portion of film sheet can be cut after running out D length of film strip. During the unwinding of film strip sufficient to supply a third defect-free film sheet, the means for reading marks (120) observes the mark (M-2), alerting the process to cut out and discard a defective film sheet which may be even longer than D. Similarly, multiple defects can be removed in a film sheet longer or shorter than D.

Typically, the film strips used in conjunction with the process embodiments of the present invention are substantially continuous in comparison to D. The film strip dimensions may vary widely, however, a conventional description of one embodiment is film strips can have a width of up to about 8 feet (2.4 meters) or more, are generally up to about 1,500 linear feet (about 460 meters) or more in length, and have a thickness of up to about 0.002 inches (about 0.000 05 meters) (typically 1 to 5000 microns) or greater. Other embodiments include widths of more than 1, 2, 4, 10, or 50 meters and less than 100 meters; lengths of more than 100, 200, 400, 1000, 2000, or 10 000 meters and less than 50 km; and thicknesses of more than 1, 10, 20, 50, 100, 200, 500, 1000, or 5000 microns and less than 0.5 cm as appropriate embodiments of the film strip.

The length D can be more than 1, 2, 4, 10, 50, or 100 meters and less than 500 meters. In some embodiments, the length D is a multiple of the film strip width, such as 0.5, 1, 2, 3, 5, 8, 10, 15, or 20 times the width, plus or minus 1-2. In certain embodiments, an extra length optionally included can be a percentage of the length D between 0 and 20%. In certain embodiments the extra amount allows the film sheet to be held onto a vacuum table by covering ports for gas removal (vacuum ports).

The film strip typically has parallel edges along its length and a substantially constant width. The film strip and film sheet shape can be independently square, rectangular, rhomboidal, parallelogram, hexagonal, octagonal, etc., without disturbing the intent and utility of the invention. In one embodiment, film sheets of one shape, removed from the film strip, can later by altered to other shapes.

In one embodiment, the longitudinal axis is defined as parallel to at least one of the lengthwise edges. In the absence of parallel edges, the longitudinal axis is defined as parallel to a straight line down the length of the unwound flat film strip which most evenly divides the film strip into two narrower film strips of substantially equal surface areas (the top area of each strip being comparable). Distances between defects in the present context are dependent upon measurement along the longitudinal axis in the length direction at the intersection of perpendiculars to the longitudinal axis that intersect the locations being measured; the distances are independent of the separation from the longitudinal axis in the width direction. Therefore, two locations on the film strip intersecting a single perpendicular from the longitudinal axis are considered to be at the same distance, e.g. have no distance of separation as defects within the meaning of this patent, along the longitudinal axis though they might have some separation between themselves measured independently of the longitudinal axis. Analogously, the location of a defect can be given in an X coordinate along the longitudinal axis (or analogously the winding direction) and a Y coordinate across the width of the film strip, but the distance and equivalently length between the defects is considered to be only the difference between their X coordinates. Therefore, distance herein emphasizes separation from a hypothetical cut entirely across the width of the film strip perpendicular to the longitudinal axis, which would typically separate a shorter film sheet from the longer film strip. In one embodiment, if a large number of 5 cm circular defects are lined up across the entire width of a 3 meter wide film strip at one location on the longitudinal axis 100 meters from the end first wound onto a roll, the defects can all be removed in a short 10 cm film sheet made by two parallel cuts of the film strip across its width. Yet if the same defects were located extended 3 meters along the longitudinal axis from meter 100 to meter 103, a film sheet of at least 3 meters would be necessary to remove all the defects and continue producing film sheets of a length D from the roll.

In FIG. 2, the distance of the first defect (90-1) to the second defect (90-2) and the distance of the first defect (90-1) to the third defect (90-3) are essentially the same along any and all longitudinal axes, which eliminate the separation in the width direction.

Film strips are capable of roll-up onto a roll. Film strips typically have a support layer that comprises one or more polymers, such as a selection from the polymer group comprising a polyethylene, polypropylene, polyester, polycarbonate, polyimide, polyamide, polysulfone, polyethersulfone, cellulose triacetate, cellulose nitrate, and combinations and copolymers thereof. The polymer group includes but is not limited to ultra high molecular weight polyethylene, ultra low molecular weight polyethylene, high molecular weight polyethylene, high density polyethylene, high density cross-linked polyethylene, cross-linked polyethylene, medium density polyethylene, low density polyethylene, linear low density polyethylene, very low density polyethylene, saturated polyesters, aromatic polyesters, aromatic alphatic polyesters, unsaturated polyesters, and other film forming polymers. In one embodiment, the polyester polyethylene terephthalate of the polymer group is present in the film strip.

In one embodiment the support layer of a film strip is coated with a coating. Useful coating methods include roller coating, dip coating, air knife coating, gravure coating, gravure offset coating, hopper coating, blade coating, wire doctor coating, spray coating, extrusion coating, etc.

The coating may comprise one or more layers. For example, a conventional thermal mass transfer film strip can comprise a support comprising polyethylene terephthalate, a light to heat conversion layer comprising aluminum or black aluminum oxide, and a thermal layer comprising a polymeric binder and a colored pigment. Other layers such as adhesive layers or interlayers are also common.

The coating may be applied neat or mixed with solvents or carriers which are subsequently partially or totally removed by drying or evaporation before use of the inventive film strip to film sheet techniques.

The coating may comprise ingredients such as binders, polymers, fillers, particles, metals, metal compounds including at least oxides or sulfides, colorants such as dyes or pigments, coating aids, flow additives, slip agents, antihalation agents, antistatic agents, surfactants, adhesives, release agents, etc.

The film strips and film sheets can be used without limitation in methods for printing, manufacture of color filters, manufacture of organic light emitting diode materials, thermal mass transfer, thermal ablative mass transfer, melt transfer, dye diffusion transfer, dye sublimation transfer, etc.

The embodiments of the present invention are not limited to use with film sheets having the aforementioned dimensions and compositions or strips of such film sheets and such dimensions are provided only for perspective purposes.

Subsequent to its manufacture, the film strip is usually wound onto a storage roll or finished roll. Thus, the film strip moves in the winding direction onto the finished roll and is oriented such that its longitudinal axis is parallel to the winding direction, as shown in FIG. 2.

As noted above, during manufacture defects such as excessive material, deficient material, blemishes, inclusions, craters, fish eyes, streaks and/or scratches form in the film. Dirt, dust and other such defects as are known for films may be found in or adhere to the film, which are problematic with respect to the end-use of the film. Thus, in order to make sure no such portion of defective film strip is used in a film sheet, the at least one defect is first recognized and positionally identified by a detection means before being excluded from use.

As used herein, “identify” and derivations thereof refers to determining whether or not the at least one defect falls within defined threshold parameters for a defect of consequence in the film strip that necessitates removal of that portion of film strip. As used herein, “recognize” and derivations thereof refers to the detection of at least one defect. As used herein, “record” and derivations thereof refers to the marking of a film strip, for example by an ink or scratch.

Thus, one embodiment of the present invention is a film strip having a longitudinal axis oriented in the winding direction and adapted for cutting into sheets having a length of at least D, comprising (a) at least one defect; and (b) at least one mark on the film strip corresponding to each defect, wherein each mark is positioned at a distance of at least D from the corresponding defect.

Another embodiment of the present invention contemplates a method of marking a film strip containing at least one defect, the film strip having a longitudinal axis oriented along a winding direction and adapted for cutting into sheets having a length of at least D, comprising:
(1) detecting the at least one defect; and
(2) recording at least one mark on the film strip corresponding to each defect, wherein each mark is positioned at a distance of at least D from the corresponding defect.

The detection means may be any conventional device, system or method known by those skilled in the art to be suitable for the detection of film defects such as, for example, an inspection station. Non-limiting examples of such devices include a high speed laser or optical charge-coupled device (CCD) camera scanner inspection station linked to interpretive software, which is a high performance imaging system providing real-time film evaluation. An example is “WebFeat” available from Dr. Schenk GmbH (Munich Germany) as well as other detection means such as “Motion Vision” image capture inspection systems from Dalsa Corporation (Waterloo, Ontario Canada) and “Graphic Vision” digital web viewing systems available from PC Industries (Gurnee, Ill. USA).

Film strips, for example donor film strips may have only a single defect, however more typically, a plurality of defects are recognized and identified. The at least one defect may be any type of defect typically encountered in the manufacture of donor film sheets and strips such as streaks or scratches as well as those defects resulting from the presence of dirt or other contaminants. The defect may be minute, in that; the quality of only a small portion of the donor film sheet has been compromised, or conversely, the defect may be of a significant width or run over a great length of the donor film sheet. Defects such as those described above are problematic because they can lead, for example, to visual disturbances in the quality of the color liquid crystal display (LCD) device image made using a color filter incorporating donor material from laser transfer from a thermal donor sheet, such as white spots or poor color balance or can create functional problems with the performance of the LCD such as shorted pixels.

The embodiments according to the present invention may provide threshold parameters whereby only particular portions of film strips having defects of a certain level of severity are removed or cut (i.e. described herein as unacceptable defects). Examples of typical threshold parameters include a defect's length and width, its location within the film strip as well as its depth. Unacceptable defects may be those defects as small as about 10 microns in length or width and about 2 microns in depth, where the potential for damage to the color filters increases as the length, width and/or depth of the unacceptable defect increases. Larger or smaller defects may pass or exceed a threshold.

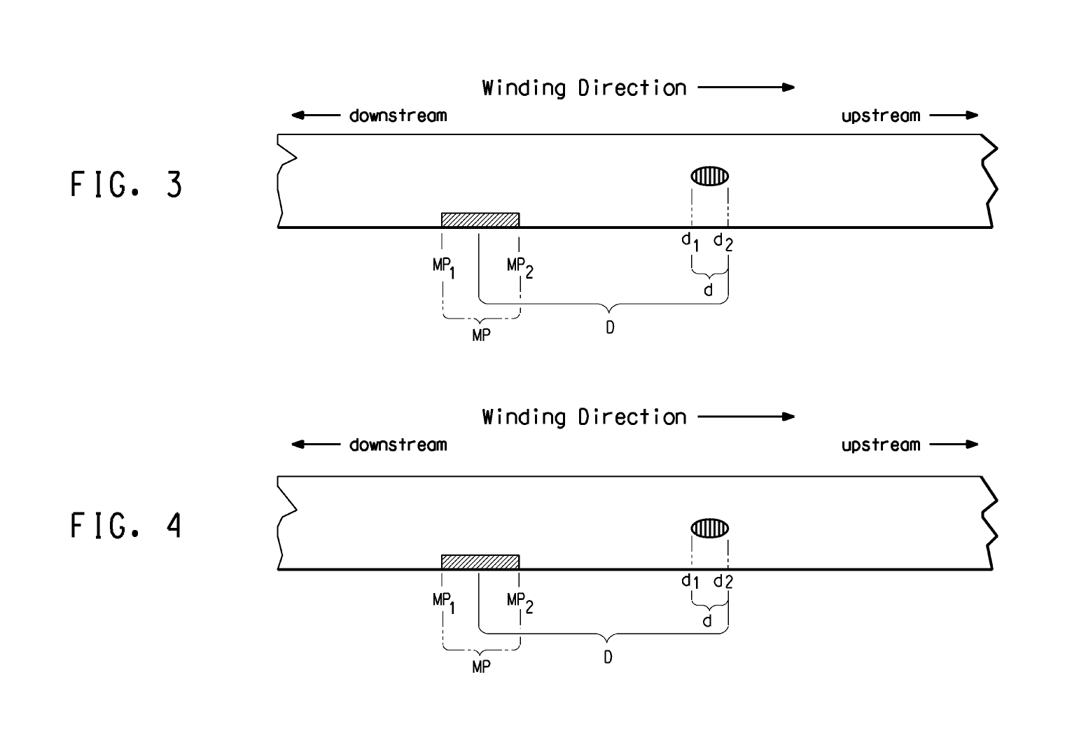

Subsequent to the identification and recognition of the at least one defect, a mark is recorded on the strip that corresponds to a particular defect. Preferably, in the winding direction, each mark is positioned downstream of the corresponding defect at a distance of at least D (as shown in FIG. 3). The distance of at least D may be varied according to the length of the film strip desired. For example, in one embodiment of the present invention, the distance of at least D is about 2 meters. Thus, the distance of at least D identifies that portion of the film strip that exists between the recorded mark and the at least one defect.

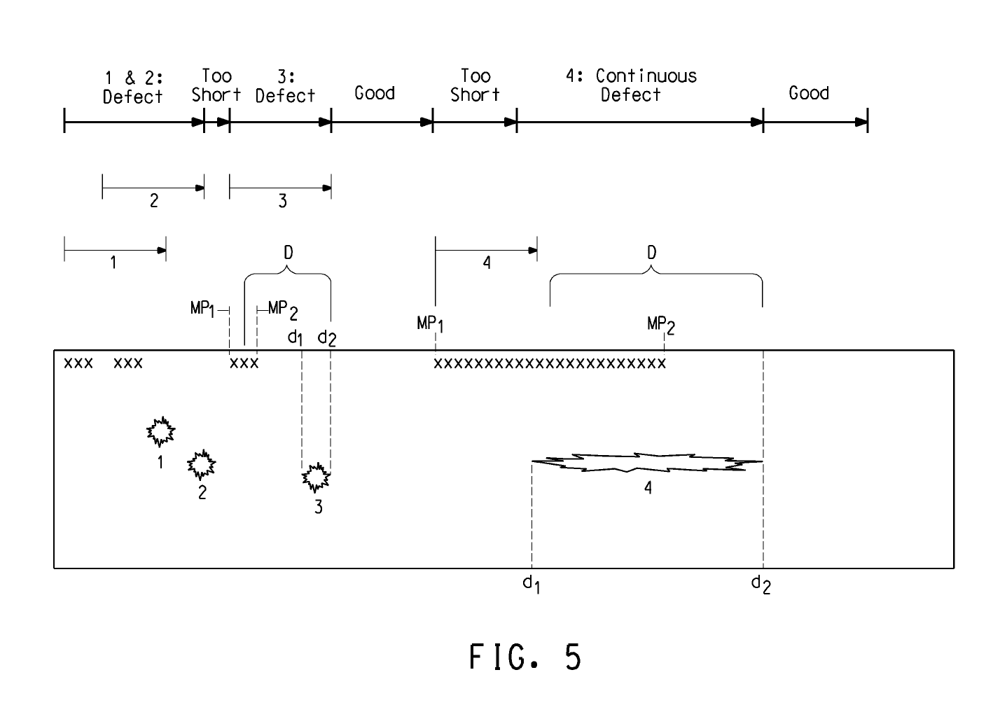

The mark may be strategically positioned upstream, downstream or at the position (where D equals zero) of the corresponding defect in the winding direction depending upon the configuration and proximity of the detection and cutting mechanisms. For example, where the mark is positioned upstream (in the winding direction) of the at least one defect, the means for detecting the at least one defect is preferably at least 1 segment of distance of at least D from the means for cutting. Preferably, as noted above, the mark is positioned downstream of the corresponding defect in the winding direction, where upon unrolling of the finished roll, the mark and its associated information (i.e. at least its position) will be encountered prior to the distance of at least D of the film strip as well as the defect itself. Thus in-process analysis of the defect information can be performed, thereby allowing for the cutting and discarding of the appropriate strip of defect-containing film in an efficient fashion. FIGS. 3, 4 and 5 show representative depictions of the arrangement of a mark corresponding to at least one defect, wherein length d is the distance between point d₁ (the downstream edge of the defect) and point d₂ (the upstream edge of the defect); length mp is the distance between mp₁ (the downstream edge of the recorded mark) and mp₂ (the upstream edge of the recoded mark), wherein the information provided by length mp correlates to the distance d or conveys information regarding the dimensions of the defect. The result is that the process can account for the entire length of the defect when removing that portion of the film strip. The portion of the film strip that either does not contain any defects or contains at least one defect within the specified threshold parameters over the necessary distance is suitable for its end-use application, where as a result, that portion of the film strip remains on course within the process embodiments of the present invention for further use.

In some instances, the distance of at least D may be identical to the length of the film strip necessary for a particular end-use. However, in those instances where an unacceptable defect is identified and recognized at some distance less than the distance of at least D, the detection means re-starts to ascertain whether another unacceptable defect will be encountered or whether or whether that portion of the film strip is suitable for an end-use application.

Typically, the mark may be deposited onto or etched into or embossed onto or cut from or affixed to the film strip using those conventional processes known in the art such as, for example, inkjet printing methods or laser etching methods. A non-limiting example of typical commercially available laser marking equipment is the ML-G9300 series marker available from Keyence Corporation (Osaka, Japan). A non-limiting example of typical commercially available inkjet marking equipment is the Excel series available from Videojet Technologies (Wood Dale, Ill., USA).

Film strips may have a working side and an opposite carrier side. The working side of the film strip and corresponding film sheet is oriented towards the substrate in the process of use of the film sheet; the carrier side is oriented away from the substrate. For example, with a donor element film sheet comprising a carrier strip such as 50 micron thick polyethylene terephthalate carrier coated on the working side with a donor layer 2 microns thick of colorant (e.g. dye, pigment) and binder (e.g. polymer), a substrate of a glass color filter support with a black matrix defining pixels can be aligned with the black matrix side of the substrate covered by the colorant-containing working side of the donor element.

Preferably marks are made on the edge of the film strip itself, even more preferably on the carrier side of the film strip, however, the recorded mark may be positioned at any point across the film strip's surface. Thus, when the finished roll is unwound or drawn out, the recorded mark may be read using those devices known within the art such as, for example, a photo diode or fiber optic/laser method. A non-limiting example of a commercially available sensor used to read the mark (a means for reading) is the FU series of fiber optics sensors available from Keyence Corporation (Osaka, Japan). The recorded mark is capable of containing and conveying position and even a plurality of information. The mark may be manipulated in its form wherein its length, width, and center point location within the film strip may convey information as to the type (opaque or transparent) of defect as well as the severity of each defect (whether acceptable or unacceptable). Information of this type may then be interpreted and analyzed to provide a detailed description of the various features of the particular defect allowing greater efficiency in determining the appropriate end-use application for the film strip.

Various end use applications may allow for the use of even those film strips that contain defects, so long as such defects are below the acceptable severity threshold level set by the operator. Thus, the defect-containing film strip may continue to be used for its particular end-use application, however the quality of that final product may be lessened in comparison to a final product utilizing a film strip free from defects. The use of threshold parameters prevents certain defect-containing film strips from being discarded when such film strip may otherwise have an appropriate utility, and thus, results in a more efficient use of a greater proportion of the finished roll.

Furthermore, some end-use applications utilize only a particular portion of a film strip, wherein a defect located in the outer perimeter of the film strip would be inconsequential in terms of an end-use application when only the central portion of the film strip is necessary for use. For instance, a given width of donor film may be used to manufacture a narrower filter where the defect locating capability can be used to ignore defects that occur outside of the area to be imaged. Thus the end use application could incorporate a defect-containing portion strip of film, yet continue to offer high quality results.

After the at least one defect has been recognized and identified and the corresponding mark(s) recorded, the embodiments of the present invention provide for the use of a cutting means for the removal of the defect-containing portions of the film that do not satisfy the threshold requirements. Thus, another embodiment contemplates a method of removing a portion of a film strip containing at least one defect, the film strip having a longitudinal axis oriented along a winding direction and adapted for cutting into sheets having a length of at least D, comprising:
(i) moving the film strip past a cutting means for cutting the film strip and a means for reading marks on the film strip corresponding to each defect, wherein each mark is positioned at a distance of at least D from the corresponding defect;
(ii) cutting the film strip at a position between the at least one defect and the corresponding mark; and
(iii) cutting the film strip when the means for reading the mark reads no additional marks for a distance of at least D, thereby removing the defect-containing portion.

Preferably, when the mark is positioned downstream of the at least one defect, in the winding direction, the film strip is first cut between the mark and the at least one defect (preferably close to the defect) and second cut upstream of the at least one defect when the means for reading the mark reads no additional upstream marks for a distance of at least D from the first mark detected, thereby removing the defect-containing portion containing at least one defect as well as possibly other defects located at a distance of less than D from at least one other defect.

In the above-described process embodiment, the means for reading the recorded mark can be encountered by the film strip before the film cutting means so that the information associated with the defect can be properly analyzed and relayed to the cutting means. Optionally the cutting means can be a distance up to D, upstream of the means for reading the detected mark in the case that analysis is rapid enough. The cutting means may be any type of commercially available cutting equipment suitable for carrying out the purpose of the process. Non-limiting examples of suitable cutting means includes commercially available rotary knives available from Applied Cutting Technology (Midlothian, Va.) and American Cutting Edge, Inc. (Centerville, Ohio).

The means for reading the mark typically instructs the cutting means to initially cut the film strip at a position between the at least one defect and the corresponding mark. The second cut is typically made upstream of the at least one defect so long as the means for reading marks does not encounter another mark over distance D, thereby removing the portion of the film strip containing the unacceptable defect. However, should another mark be read at a distance that is less than distance D, the second cut is not made until a portion of the film strip without marks having length D is encountered or recognized.

Once the film strip containing an unacceptable defect has been cut and discarded, the remaining sheets that are either defect-free or contain acceptable defects can be sheeted onto a drum and ultimately applied to a substrate for use in a particular end-use product. In addition, another embodiment of the present invention relates to a method of marking a film strip containing at least one defect, the film strip having a longitudinal axis oriented along a winding direction and adapted for cutting into sheets having a length D, comprising:
(1) detecting the at least one defect; and
(2) recording at least one mark on the film strip corresponding to each defect, wherein each mark is positioned at a distance D from the corresponding defect; and
(3) removing a portion of the film strip, comprising:
   A) moving the film strip containing at least one defect past a cutter for cutting the film strip and a means for reading marks on the film strip corresponding to each defect, wherein each mark is positioned at a distance of at least D from the corresponding defect;
   B) cutting the film strip at a position between the at least one defect and the corresponding mark; and
   C) cutting the film strip when the means for reading the mark reads no additional marks for a distance of at least D, thereby removing the defect-containing portion.

Preferably, when the mark is positioned downstream of the at least one defect, in the winding direction, the film strip is cut upstream of the at least one defect when the means for reading the mark reads no additional upstream marks for a distance of at least D, thereby removing the defect-containing portion.

Commonly, the means of defect detection and the means of marking are located at the film manufacturing site, while the means for reading the mark and the means of cutting can be located at a different site or sites for film use. One advantage of the present invention is that since a single film manufacturing site can supply many different sites for film use, an expensive means of defect detection can be bought for just one site, while less expensive means of reading the mark can be bought for many sites of use, thereby lowering overall costs over the alternative of having a means of defect detection at every site.

It is also advantageous to compactly make the equipment capable of carrying out the invention. In one embodiment, the means of reading the mark and the means of cutting are separated by a distance E measured along the longitudinal axis. The distance E can be on the order of the distance D; for example E can be chosen from less than or equal to one fifth of D, less than or equal to one third of D, less than or equal to one half of D, or less than or equal to D.

It is common that the width of the film strip is comparable to the distance D. For example, D can be greater than or equal to one fifth of the film strip width W, greater than or equal to one third of the film strip width W, greater than or equal to one half of the film strip width W, greater than or equal to the film strip width W, greater than or equal to twice the film strip width W, greater than or equal to thrice the film strip width W, less than one third the film strip width W, less than one half the film strip width W, less than the film strip width W, less than twice the film strip width W, less than ten times the film strip width W, or a combination of such possible limitations.

### INVENTORY OF REFERENCES WITHIN FIGURES

10 Elements of a radiation-imagable donor element and receiver element assemblage
20 color filter receiver element
30 non-defective film sheet
40 vacuum table
50 ports providing vacuum
60 defect-containing film strip
70 roll holding all or part of a defect-containing film strip
80 longitudinal axis (as for 80′, parallel to 80)
85 winding direction of the roll, i.e. the direction of movement of the film strip as wound onto the roll
90-1 short defect on the film strip
90-2 long defect on the film strip, partially wound onto the roll
90-3 defect on film strip, at a portion overlapping the defect-containing film strip portion resulting from defect 90-2
110 means of marking the film strip for presence of a defect
120 means for reading marks
125 means of defect detection
130 axis of rotation of roll
135 counter-clockwise rotation of roll about its axis to bring film strip onto the roll
140 means of cutting the film strip
150-0 free end of the film strip
150-1 location of first cut of film strip, to produce defect free film sheet S-1, and a new free end of the film strip
150-2 location of second cut of film strip, to produce defect free film sheet S-2, and a new free end of the film strip
150-3 location of third cut of film strip, to produce defect-containing film sheet T-1, and a new free end of the film strip
150-4 location of fourth cut of film strip, to produce defect free film sheet S-3, and a new free end of the film strip
150-5 location of fifth cut of film strip, to produce defect-containing film sheet T-2, and a new free end of the film strip
M a mark corresponding to a defect
M-1
S-1 first designated defect free film strip
S-2 second designated defect free film strip
S-3 third designated defect free film strip
T-1 first portion of defect-containing film strip to be diverted
T-2 second portion of defect-containing film strip to be diverted
D distance measured along a longitudinal axis of a defect-free film sheet cut from the film strip
E distance measured along a longitudinal axis between the means for reading marks and the means of cutting the film strip
F distance measured along a longitudinal axis between the means for reading marks and the axis of the roll

What is claimed is:

1. A film strip having a longitudinal axis oriented in a winding direction and adapted for cutting into sheets having a length of at least D, comprising:
at least one defect; and
at least one mark on the film strip corresponding to each defect, wherein each mark is positioned at a distance of at least D from the corresponding defect.

2. The film strip according to claim 1, wherein the distance D is greater than or equal to the width of the film strip.

3. The film strip according to claim 1, wherein the film strip comprises a selection from the polymer group consisting of polyethylene, polypropylene, polyester, polycarbonate, polyimide, polyamide, polysulfone, polyethersulfone, cellulose triacetate, cellulose nitrate, and combinations and copolymers thereof.

4. The film strip according to claim 1, wherein at least a portion of the film strip is wound on a roll.

5. The film strip according to claim 1, wherein the film strip comprises a colored transferable layer and an adjacent support layer.

6. A method of marking comprising:
providing a film strip containing at least one defect, the film strip having a longitudinal axis oriented along a winding direction and adapted for cutting into sheets having a length of at least D,
detecting the defect; and
marking a mark on the strip corresponding to the defect, wherein the mark is positioned at a distance of at least D from the defect.

7. The method according to claim 6, wherein the mark is positioned downstream in the winding direction from the defect.

8. The method according to claim 6, wherein the mark is positioned upstream in the winding direction from the defect.

9. A method of removing a defect-containing portion of a film strip comprising:
providing a film strip having a defect and a corresponding mark and having a longitudinal axis oriented along a winding direction and adapted for cutting into sheets having a length of at least D, wherein the corresponding mark is positioned at a distance of at least D from the defect;
moving a portion of the film strip containing the corresponding mark past a means for reading marks on the film strip corresponding to each defect,
reading the corresponding mark,
moving a second portion of the film strip between the defect and the corresponding mark past a means for cutting, first cutting the film strip,
moving a third portion of film strip past the means for reading marks, and
second cutting the film strip when the means for reading the mark reads no additional marks for a distance of at least D, thereby removing the defect-containing portion from the film strip.
